(19) United States
(12) Patent Application Publication
(10) Pub. No.: US 2007/0056886 A1
(43) Pub. Date: Mar. 15, 2007

(54) Sorting apparatus, mail processing system, and sorting method

(75) Inventor: Hideto Yui, Yokohama-shi (JP)

Correspondence Address: PILLSBURY WINTHROP SHAW PITTMAN, LLP, P.O. BOX 10500, MCLEAN, VA, 22102, US

(73) Assignee: Kabushiki Kaisha Toshiba, Tokyo (JP)

(21) Appl. No.: 11/517,454

(22) Filed: Sep. 8, 2006

(30) Foreign Application Priority Data
Sep. 15, 2005 (JP) 2005-268520

(51) Int. Cl. B07C 5/00

(52) U.S. Cl. 209/584

(57) ABSTRACT

In dispatch sorting, a sorting system requires an operator to input sorting information through an information input unit for mails whose sorting information could not be identified and sorts the mails into delivery stations based on the information input as the sorting information through the information input unit, as well as stores the information input through the information input unit in an input information database. Further, the sorting system sorts the input information stored in the input information database into delivery stations, as well as stores the summary data representing per-digit or per-hierarchy number of the input information in a summary data table.

### CROSS-REFERENCE TO RELATED APPLICATIONS

This application is based upon and claims the benefit of priority from prior Japanese Patent Application No. 2005-268520, filed Sep. 15, 2005, the entire contents of which are incorporated herein by reference.

### BACKGROUND OF THE INVENTION

1. Field of the Invention

The present invention relates to a sorting apparatus and sorting method which sort mails based on sorting information appended to the mails and a mail processing system having the sorting apparatus and a server for storing processing data used by the sorting apparatus.

2. Description of the Related Art

There is known, as a mail processing system for processing mail such as postcard, letter, parcel, etc., a system which sorts mails based on sorting information appended to the mails. In such a mail processing system, the mails are collected and sorted at a plurality of locations. For example, mails collected at respective locations are sorted into each location in charge of delivery based on a part of sorting information appended to mails. The sorted mails are conveyed to each location, at which they are further sorted based on the sorting information. This mail processing system allows the location in charge of delivery to sort the mails based on sorting information and deliver them to destinations corresponding to the sorting information.

The location that collects mails and sorts them into each location in charge of delivery is called, e.g., “collection station (dispatch station)”, and the location that sorts the mails conveyed from the collection station into delivery destinations is called “delivery station”. That is, a sorting apparatus in the collection station sorts the collected mails into each delivery station based on a part of their sorting information.

More specifically, a sorting apparatus in the collection station determines the sorting information of the mails, prints a code indicating the sorting information corresponding to the mails, and sorts the mails into delivery stations (sorting for dispatch). The mails that have thus been sorted are conveyed from the collection station to the delivery stations by a transportation means such as a track. A sorting apparatus in the delivery station receives the mails from the collection station and sorts them in order of the carrier's delivery route (determines routing) based on address information determined based on the barcode printed on the mails. This process allows the mails that have been sorted by the sorting apparatus in the delivery station to be delivered to their destinations by postmen.

In the abovementioned mail processing system, the entire part of sorting information appended to the mails is determined in the collection station for improving the efficiency of processing in the entire system. Therefore, in the collection station, when the sorting information cannot be determined, a clerk needs to manually input the sorting information.

In the system described above, however, performing sorting of mails into delivery stations as a minimum processing requirement enables sorting of the mails into delivery stations. Therefore, in some cases, mails to each of which the entire part of the sorting information has not been input in the collection station may be conveyed to the delivery stations. In such a case, the delivery station needs to input the information that has not been input (i.e., the entire part of the sorting information). This may result in deterioration of processing efficiency in the entire system. Further, there is no mechanism for the collection station to calculate and integrally manage processing data in a conventional mail processing system. Therefore, it is impossible for the collection station to grasp processing status or evaluate processing quality, preventing improvement in the processing efficiency of the entire mail processing system.

### BRIEF SUMMARY OF THE INVENTION

An object of an embodiment of the present invention is to provide a sorting apparatus, a mail processing system, and a sorting method which can manage the processing status in each sorting apparatus to thereby improve the processing efficiency of the entire system.

According to one aspect of the present invention, there is provided a sorting apparatus which sorts mails, comprising: an input section which inputs sorting information appended to the mails; a sorting section which sorts the mails based on the information input through the input section as the sorting information; a determination section which determines the ratio of the information input through the input section as the sorting information relative to the entire sorting information of the mails sorted by the sorting section; and a counting section which counts the determination results obtained by the determination section.

According to a second aspect of the present invention, there is provided a mail processing system having a sorting apparatus which sorts mails and a server unit which can communicate with the sorting apparatus, wherein the sorting apparatus comprises: an input section which inputs sorting information appended to the mails; a sorting section which sorts the mails based on the information input through the input section as the sorting information; and a transmission section which transmits, to the server unit, information input through the input section as the sorting information for the mails sorted by the sorting section, and the server unit comprises: a determination section which determines the ratio of the information input through the input section of the sorting apparatus as the sorting information relative to the entire sorting information of the mails sorted by the sorting section of the sorting apparatus based on the information received from the sorting apparatus; and a counting section which counts the determination results obtained by the determination section.

According to a third aspect of the present invention, there is provided a sorting method for sorting mails, comprising: inputting sorting information appended to the mails; sorting the mails based on the information input as the sorting information; determining the ratio of the input information relative to the entire sorting information of the sorted mails; and counting the determination results.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a view schematically showing a configuration example of a mail processing system;

FIG. 2 is a view schematically showing a configuration example of a sorting system;

FIG. 3 is a view showing a configuration example of an input information database;

FIG. 4 is a view showing a configuration example of an input information database;

FIG. 5 is a view showing a configuration example of an input information database;

FIG. 6 is a view showing a configuration example of a summary data table;

FIG. 7 is a flowchart for explaining a processing procedure of dispatch sorting performed in the collection station; and

FIG. 8 is a flowchart for explaining a processing procedure of dispatch sorting performed in the collection station.

### DETAILED DESCRIPTION OF THE INVENTION

An embodiment of the present invention will be described below with reference to the accompanying drawings.

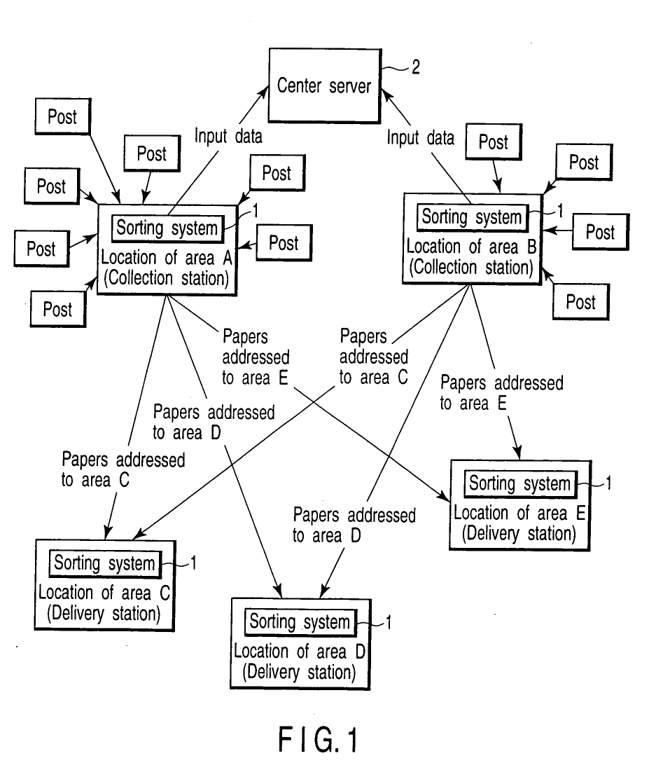

FIG. 1 is a view schematically showing a configuration example of a mail processing system.

The mail processing system is a system for sorting mail (postcard, letters, parcels, etc.). The mails are deliveries such as mails or articles based on sorting information such as address information. It is assumed in the present embodiment that a sorting system 1 serving as a sorting apparatus sorts mails based on address information. Further, it is assumed that the address information serving as the sorting information includes a plurality of hierarchies. For example, the address information serving as the sorting information includes 7-digit (or 5-digit) number information corresponding to a postal code and information (information such as number that can be coded) continued from the number information.

In the configuration example shown in FIG. 1, the mail processing system includes a plurality of sorting systems 1 serving as a sorting apparatus and a center server 2.

As shown in FIG. 1, the sorting systems (sorting apparatuses) 1 are provided in a plurality of locations (stations), respectively. Each of the sorting systems 1 is connected via a network or the like to the center server 2 configured to manage the information stored in each of the sorting systems 1. That is, the entire mail processing system that processes the mails includes a plurality of the sorting systems 1 provided in a plurality of stations and center server 2 connected respectively to the sorting systems 1. The mail processing system according to the present embodiment is applied to, e.g., a system for delivering deliveries, to which the address information has been appended, to destinations corresponding to the address information.

The mail processing system is so designed as to cover the entirety of a wide service area (e.g., one country or a plurality of countries). Such a mail processing system sort deliveries collected at various locations within a service area into delivery destinations. To this end, the service area is divided into a plurality of areas and a location (station) having at least one sorting system is provided in each area. Some stations that sort deliveries collected from areas of responsibility (into delivery stations) function as a collection station and other stations that sort the deliveries conveyed from the collection station (in order of the carrier's delivery route) function as a delivery station.

That is, the sorting system 1 functioning as a first station (collection station) sorts deliveries collected within an area of responsibility into second stations (delivery stations) provided at areas covering delivery destinations. In the example shown in FIG. 1, locations provided in areas A and B function as a collection station and locations provided in areas C, D, and E function as a delivery station. Incidentally, the collection station sorts the mails having destinations indicating the area of responsibility into its own station. With the mail processing system, deliveries collected from a wide area can surely be delivered to their destinations.

The present embodiment assumes a mail processing system that processes mails (deliveries) to which sorting information has been appended. Further, the present embodiment assumes, as sorting information appended to the mails, address information including 7-digit number information and information having a plurality of hierarchies (information having a plurality of hierarchies that can be replaced by numbers) continued from the 7-digit number information. In the present embodiment, the location that delivers mails collected in its area of responsibility to a location provided for each destination area is called “collection station”, and the location that sorts the mails whose destination indicates an area of its own responsibility into delivery destinations for delivery is called “delivery station”.

A configuration of the sorting system 1 will next be described.

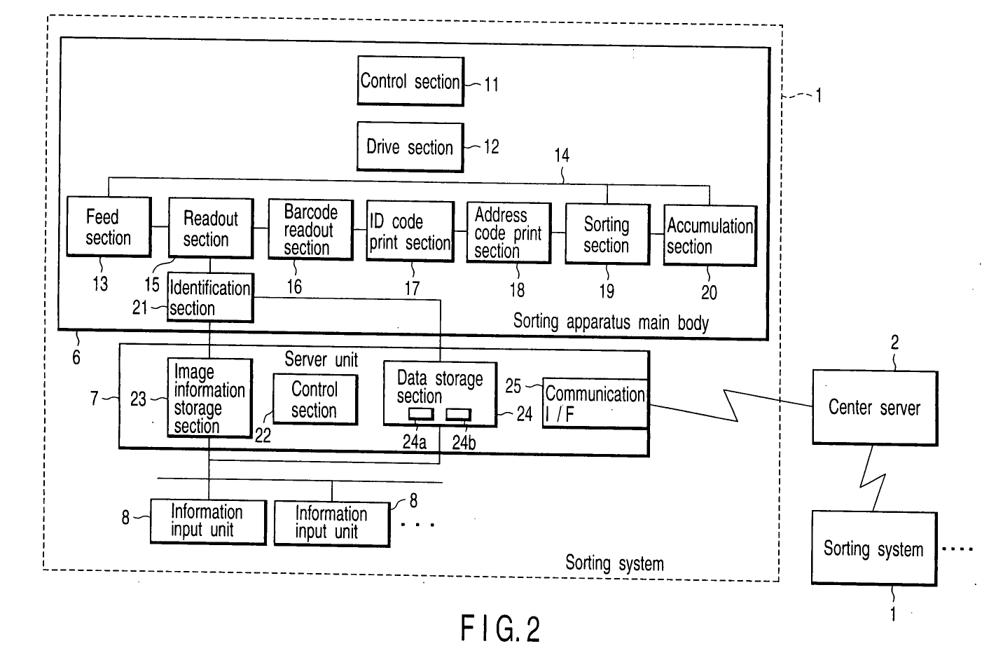

FIG. 2 is a block diagram schematically showing a configuration of the sorting system 1.

As shown in FIG. 2, the sorting system 1 includes a sorting apparatus main body 6, a server unit 7, and an information input unit 8.

The sorting apparatus main body 6 includes, as shown in FIG. 2, a control section 11, a drive section 12, a feed section 13, a feed path 14, a readout section (readout means) 15, a barcode readout section 16, an ID code print section 17, an address code print section 18, a sorting section (sorting means) 19, an accumulation section 20, an identification section (identification means) 21, and the like.

The control section 11 controls the operation of the entire sorting apparatus main body 6. The drive section 12 is controlled by the control section 11. The drive section 12 drives the components in the sorting apparatus main body 6. The feed section 13 picks up, one by one, mails (e.g., mails) to be sorted which are set by an operator and feeds them to the feed path 14. The feed path 14 feeds the mails picked up by the feed section 13 to the components of the rear stage.

The readout section (scanner) 15 is disposed on the downstream side of the feed section 13 in the direction that the feed path 14 feeds the mails. The readout section 15 reads out an image on the surface of the mails picked up by the feed section 13 and fed by the feed path 14, the surface including address information serving as sorting information. The barcode readout section 16 reads out barcode information such as an address code and ID code printed on the mails.

The ID code print section 17 prints an ID code serving as an identification code for identifying the mails (or image on the mails that has been read out by the readout section 15) thereon to which a barcode is not appended. The address code print section 18 prints barcode information (address code) indicating address information written on the mails. The address code print section 18 prints the address code based on the address information determined by the identification section 21 or address information input through the information input unit 8.

The sorting section 19 sorts mails based on the address information. The accumulation section 20 accumulates the mails sorted by the sorting section 19.

The identification section 21 extracts the address information from the image on the mails read out by the readout section 15 and determines their sorting destinations. The identification section 21 includes a character recognition unit or the like. In the identification section 21, processing time for recognizing characters (recognition processing time) is set depending on the mails feeding time length set in the sorting apparatus main body 6, making it possible for the identification section 21 to obtain a result of the character recognition within the recognition processing time.

The server unit 7 includes, as shown in FIG. 2, a control section 22, an image information storage section 23, a data storage section 24, a communication interface (I/F) 25, and the like. The control section 22 controls the operation of the entire server unit 7. The control section 22 has a function of distributing information such as images stored in the image information storage section 23 to the information input unit 8. The control section 22 has also a function of supplying data stored in the data storage section 24 to the identification section 21.

The image information storage section 23 stores, as video coding information (VCD information) for input of address, information including images of mails whose address information could not be recognized by the identification section 21 together with their mail ID information and their information about a part that could be recognized in an associated manner. The information for input stored in the image information storage section 23 is distributed to the respective information input units 8 under the control of the control section 22.

The data storage section 24 stores information input through the information input unit 8. Further, the data storage section 24 has an input information database 24a and a summary data table 24b.

The input information database 24a is a database for storing information that has been input, as the address information of mails, through the respective information input units 8. The input information is stored in such a manner that each digit of the address information (each digit of 7-digit number included in the address information) input through the respective information input units 8 and each hierarchy (each hierarchy of the information continued from the number information included in the address information) can be identified.

The summery data table 24b stores summary data concerning the address information input through the respective information input units 8. The summary data includes the per-digit or per-hierarchy number of the address information input through the respective information input units 8. The summary data as described above is counted on each delivery station basis.

The communication interface 25 is an interface for communicating with the center server 2.

The information input unit 8 is a device for an operator to input the address information based on the video coding information such as an image of the mails distributed from the server unit 7. For example, a plurality of the information input units 8 are connected to a single server unit 7. The operator uses the information input unit 8 to notify processing status to the server unit 7 and input the address information based on the video coding information corresponding to the processing status which is distributed from the server unit 7.

The information input unit 8 includes a control section, a storage section, a display section, an operation section, and the like. The information input unit 8 displays the image of the mails included in the video coding information received by the server unit 7 on the display section and, in this state, receives an input of the address information and the like from the operator. Further, the information input unit 8 associates the address information input by the operator with the mail ID information and transfers them as video coding information (processed data) to the server unit 7. The sorting apparatus main body 6 has a function of sorting the mails based on the video coding information stored in the server unit 7.

An overview of a processing flow for the mails in the entire mail processing system according to the present embodiment will next be described.

In the mail processing system according to the present embodiment, mails are processed in the sorting systems provided at a plurality of locations (stations). At the location where the mails are collected, dispatch sorting is performed to sort the mails into respective locations in charge of delivery. The location that sorts the collected mails into respective locations in charge of delivery is called a collection station. The location that has received the mails subjected to the dispatch sorting by the collection station performs delivery sorting (routing processing) to sort mails in a predetermined order (e.g., in order of the carrier's delivery route). The location that sorts the mails that have been subjected to the dispatch sorting according to a predetermined order is called a delivery station.

As described above, in the mail processing system, each delivery station sorts the mails that have been subjected to the dispatch sorting by the collection station according to a predetermined order. The mail processing system as described above operates according to a predetermined operation rule in order to perform processing for the mails smoothly and effectively. For example, it can be said that determining the entire address information in the dispatch sorting in the collection station allows the entire mail processing system to effectively process the mails. Therefore, in the present embodiment, the collection station performs the dispatch sorting with first 3 digits of the 7-digit number information. Further, in the present embodiment, the collection station inputs 7-digit number information to the mails to be directed to the delivery station determined by first 2 digits while it inputs the entire part of the address information to the mails directed to the delivery station determined by first 3 digits.

The input information database 24a will next be described.

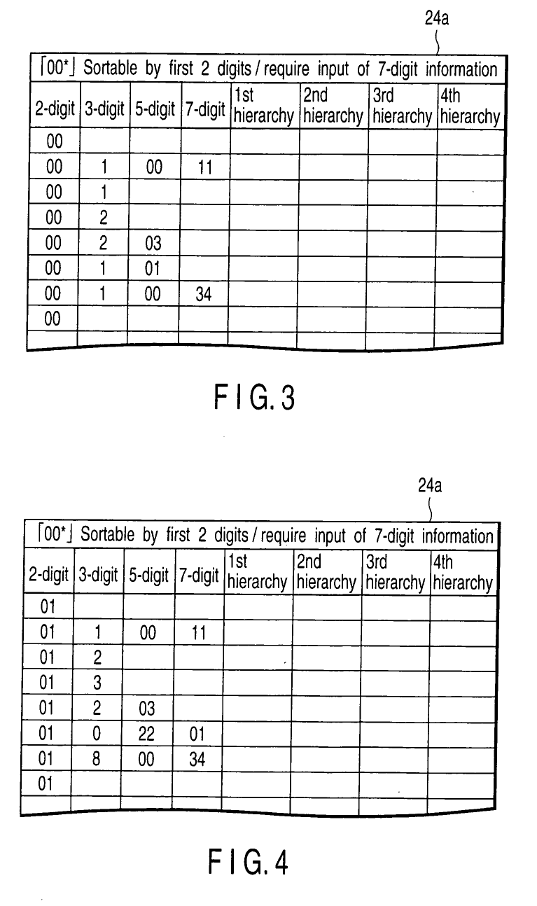

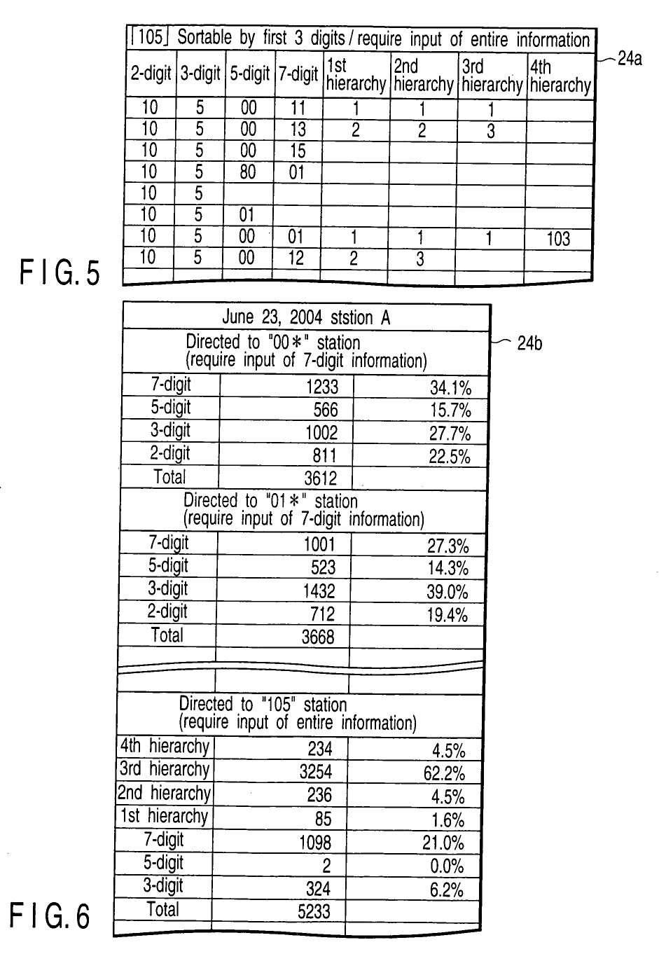

FIGS. 3, 4, and 5 are views showing examples of the input information database 24a that stores the input information that has been input, as the address information, through the information input unit 8. FIG. 3 shows an example in which the input information database 24a stores the input information corresponding to the address information directed to the delivery station determined by first 2 digits “00” of the 7-digit number information. FIG. 4 shows an example in which the input information database 24a stores the input information corresponding to the address information directed to the delivery station determined by first 2 digits “01” of the 7-digit number information. FIG. 5 shows an example in which the input information database 24a stores the input information corresponding to the address information directed to the delivery station determined by first 3 digits “105” of the 7-digit number information. As shown in FIGS. 3, 4, and 5, the input information database 24a stores information input for each delivery station.

The abovementioned operation rule defines that 7-digit number information is fixed for the address information sortable by first 2 digits of the 7-digit number information. Accordingly, as the input information database 24a shown in FIGS. 3 and 4, information represented by the first 2 digits has been input for the address information sortable by the first 2 digits as the minimum information required for sorting the mails for dispatch. However, in the examples shown in FIGS. 3 and 4, 3rd and subsequent digits have not been input in some fields of the table. This shows that 3rd and subsequent digits are actually absent in some fields of the table although the entire 7-digit information needs to be input in the operation rule described above.

That is, in the case where the target delivery station can be identified by the first 2 digits, the dispatch sorting in the sorting system 1 provided in the collection station can sort the mails to which only 2 digits have been input. However, the address information of the mails whose entire address information has not been fixed in the dispatch sorting in the sorting system provided in the collection station needs to be fixed in the delivery sorting in the sorting system provided in the delivery station. This results in deterioration of mail processing efficiency in the entire system. In particular, it takes a lot of time and trouble for the delivery station to process the mails that have been sorted for dispatch by the collection station where input rate of the address information is low.

The input information database 24a stores “2-digit” (first and second digits), “3-digit”, “5-digit” (fourth and fifth digits), and “7-digit” (sixth and seventh digits) in a separated manner. This makes it easy to differentiate mails including information up to 2nd digit, those including information up to 3rd digit, those including information up to 5th digit, and those including information up to 7th digit from one another. In other words, with the input information database 24a, it is possible to grasp the number of mails to which the information needed to be fixed under the operation rule has not been input in the dispatch sorting or the per-digit number of information that have not been input.

Further, the abovementioned operation rule defines that the entire address information is fixed for the address information sortable by first 3 digits of the 7-digit number information. Accordingly, in the example of the input information database 24a shown in FIG. 5, information represented by the first 3 digits has been input for the address information sortable by the first 3 digits as the minimum information required for sorting the mails for dispatch. However, in the example shown in FIG. 5, 4th and subsequent digits have not been input in some fields of the table. This shows that 4th and subsequent digits are actually absent in some fields of the table although the entire address information needs to be input in the operation rule described above.

That is, in the case where the target delivery station can be identified by the first 3 digits, the dispatch sorting in the sorting system 1 provided in the collection station can sort the mails to which only 3 digits have been input. However, the address information of the mails whose entire address information has not been fixed in the dispatch sorting in the sorting system provided in the collection station needs to be fixed in the delivery sorting in the sorting system provided in the delivery station. This results in deterioration of mail processing efficiency in the entire system. In particular, it takes a lot of time and trouble for the delivery station to process the mails that have been sorted for dispatch by the collection station where input rate of the address information is low.

The input information database 24a stores, for each input information, “2-digit” (first and second digits), “3-digit”, “5-digit” (fourth and fifth digits), “7-digit” (sixth and seventh digits), “1st hierarchy”, “2nd hierarchy”, “3rd hierarchy”, and “fourth hierarchy” in a separated manner. This makes it easy to differentiate mails including information up to 2nd digit, those including information up to 3rd digit, those including information up to 5th digit, those including information up to 7th digit, those including information up to 1st hierarchy, those including information up to 2nd hierarchy, those including information up to 3rd hierarchy, or those including information up to 4th hierarchy from one another. In other words, with the input information database 24a, it is possible to grasp the number of mails to which the information needed to be fixed under the operation rule has not been input in the dispatch sorting or the per-digit number of information that have not been input.

The summary data table 24b will next be described.

FIG. 6 is a view showing an example of the summary data table 24b storing the summary data obtained by counting the input information that has been input, as the address information, through the information input unit 8.

As shown in FIG. 6, the summary data table 24b stores summary data obtained by counting per-digit or per-hierarchy number of input information on each delivery station basis.

The abovementioned operation rule defines that 7-digit number information is fixed for the address information sortable by first 2 digits of the 7-digit number information. Accordingly, the summary data table 24b shown in FIG. 6 stores, as summary data, the number of mails including information up to 2nd digit and its ratio relative to the total number thereof, the number of mails including information up to 3rd digit and its ratio relative to the total number thereof, the number of mails including information up to 5th digit and its ratio relative to the total number thereof, and the number of mails including information up to 7th digit and its ratio relative to the total number thereof, for each delivery station determined by first 2 digits. Thus, with the summary data table 24b as described above, it is possible to easily grasp per-digit number of mails and its ratio relative the total number thereof for each delivery station determined by first 2 digits.

Further, the abovementioned operation rule defines that the entire address information is fixed for the address information sortable by first 3 digits of the 7-digit number information. Accordingly, the summary data table 24b shown in FIG. 6 stores, as summary data, the number of mails including information up to 2nd digit and its ratio relative to the total number thereof, the number of mails including information up to 3rd digit and its ratio relative to the total number thereof, the number of mails including information up to 5th digit and its ratio relative to the total number thereof, the number of mails including information up to 7th digit and its ratio relative to the total number thereof, the number of mails including information up to 1st hierarchy and its ratio relative to the total number thereof, the number of mails including information up to 2nd hierarchy and its ratio relative to the total number thereof, the number of mails including information up to 3rd hierarchy and its ratio relative to the total number thereof, and the number of mails including information up to 4th hierarchy and its ratio relative to the total number thereof for each delivery station determined by first 3 digits. Thus, with the summary data table 24b as described above, it is possible to easily grasp per-digit or per-hierarchy number of mails and its ratio relative the total number thereof for each delivery station determined by first 3 digits.

The summary data table 24b as described above enables easy grasping of data entry made through the information input unit in the collection station performing the dispatch sorting, enabling the collection station to easily evaluate its approach to the dispatch sorting and its processing quality. Further, the summary data table 24b can count, for each delivery station, the data representing data entry, enabling easy evaluation of processing quality on each delivery station basis.

Details of the mails sorting processing (dispatch sorting) performed by the sorting system in the collection station will next be described.

As described above, the collection station is a station that collects mails to which given address information has been appended and distributes them to delivery stations. The dispatch sorting is processing that sorts the collected mails into delivery stations (locations in charge of delivery). That is, the sorting system in the collection station performs the dispatch sorting to sort the collected mails.

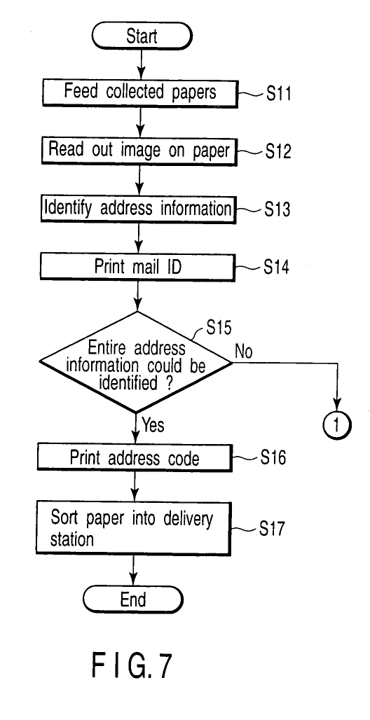

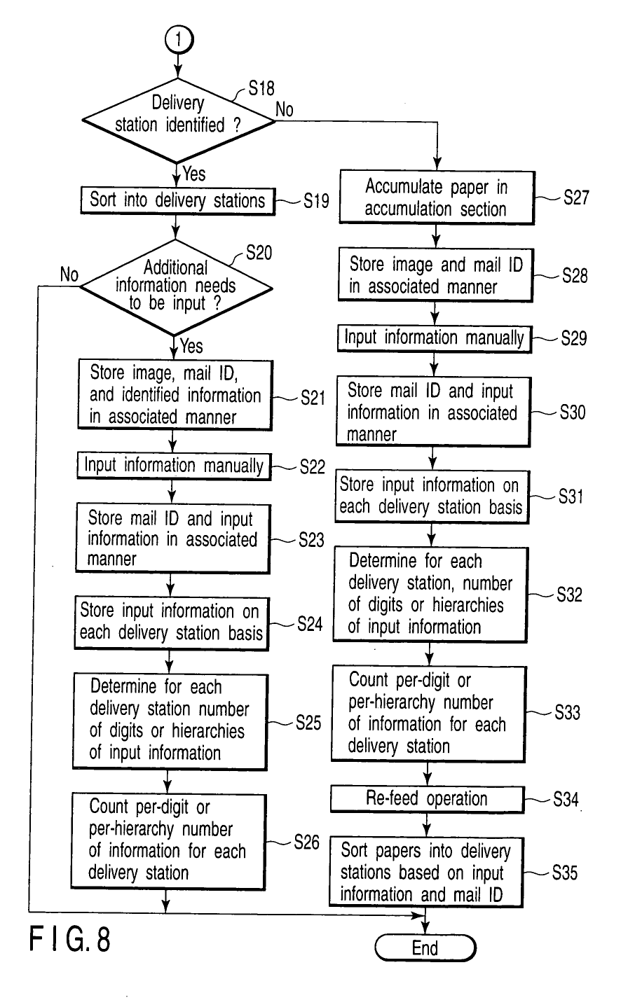

FIGS. 7 and 8 are flowcharts each explaining a processing procedure of the dispatch sorting performed by the sorting system in the collection station.

An operator of the collection station sets the collected mails in the feed section 13 of the sorting apparatus main body 6 and operates an operation section (not shown) to start the dispatch sorting. Then, the control section 11 of the sorting apparatus main body 6 picks up, one by one, the mails set in the feed section 13 and feeds them by the feed path 14 (step S11). Subsequently, the readout section 15 reads out an image on the mail fed by the feed path 14 (step 12). The readout section 15 then sends the readout image to the identification section 21. The identification section 21 identifies address information based on the image sent from the readout section 15 (step S13). A result of the identification processing performed by the identification section 21 is supplied to the control section 11. At the same time, the ID code print section 17 prints a mail ID for identifying the mail thereon fed by the feed path 14 (step S14).

In the case where the identification section 21 could identify the entire part of the address information of a mail (YES in step S15), the address code print section 18 prints an address code representing the identified address information on the mail (step S16). The mail on which the address code representing the address information has been printed by the address code print section 18 is then sorted by the sorting section 19 based on the printed address information (step S17).

In the case where the identification section 21 could not identify the entire address information of a mail (NO in step S15), the control section 11 determines whether the identification section 21 could obtain the minimum information (information uniquely indicating a destination delivery station) required to sort the mail (step S18).

This dispatch sorting sorts mails into delivery stations. Therefore, the control section 11 determines whether the identification section 21 could identify the information uniquely indicating a destination delivery station in step S18. For example, in the case where a given delivery station is identified by first 3 (or 2) digits of the 7-digit number information, the control section 11 determines whether the identification section 21 could identify at least 3 (or 2) digits of the number information.

When determining that the identification section 21 could identify the information uniquely indicating a destination delivery station, that is, the identification section 21 could identify a destination delivery station (Yes in step S18), the control section 11 uses the sorting section 19 to sort the mail based on the information uniquely indicating a target delivery station (step S19). In this case, the entire address information of the mail is not identified. Therefore, the control section 11 determines whether there is any information to be input in addition to the identification result obtained by the identification section 21 (step S20). This determination is made based on the operation rule previously defined in the mail processing system. That is, the level to which the address information needs to be fixed in the dispatch sorting is previously defined as the operation rule of the mail processing system.

It is assumed, for example, that the operation rule defines a delivery station requiring only 7-digit information and another delivery station requiring the entire address information. Since the entire address information of the mail is not identified, the control section 11 determines there is any information to be input in the case where the mail is directed to the delivery station requiring the entire address information. Further, the control section 11 determines based on the identification information made by the identification section 21 whether there is any information to be input for the mail directed to the delivery station only requiring 7-digit number information. That is, in the case where the 7-digit number information could be identified, the control section 11 determines that there is no information to be additionally input; in the case where the 7-digit number information could not completely be identified (for example, in the case where only first 3 or 2 digits of the 7-digit number information could be identified), the control section 11 determines whether there is any information to be input through the information input unit 8 in addition to the identification result obtained by the identification section 21.

When determining that there is no information to be input (NO in step S20), the control section 11 ends the processing for the mail; when determining that there is any information to be input (YES in step S20), the control section 11 generates input information corresponding to one mail by associating the image and mail ID of the mail and information identified by the determination section 21 and transfers it to the server unit 7.

After receiving the input information from the sorting apparatus main body 6, the control section 22 of the server unit 7 stores the input information in the image information storage section 23 (step S21). The control section 22 of the server unit 7 transfers the input information stored in the image information storage section 23 to the information input unit 8, considering the processing situation of the information input unit 8. The address information then input to the information input unit 8 based on the input information transferred from the server unit 7 (step S22). For example, the information input unit 8 displays the image of the mail or information identified by the determination section 21 on a display unit (not shown) and receives an input of the address information from the operator.

At this time, the information input unit 8 requires the operator to input the address information up to the level defined by the abovementioned operation rule in principle. However, the mail has been sorted based on the information indicating a destination delivery station even if the information satisfying the required level has not been input. That is, although it is necessary to input the address information up to the required level in the operation rule, there is actually the possibility of absence of the required part of the address information.

After the operator has input the required information, the information input unit 8 associates the input address information and mail ID with each other and sends it to the server unit 7 as processed data. Upon receiving the processed data from the information input unit 8, the control section 22 of the server unit 7 stores, in the data storage section 24, the input information and mail ID in an associated manner based on the processed data received by the information input unit 8 (step S23) and stores, in the input information database 24a, the input information on each delivery station basis (step S24).

After storing the processed data from the information input unit 8 in the data storage section 24, the control section 22 of the server unit 7 determines, for each delivery station, the digit number or hierarchy of the input information stored in the input information database 24a (step S25). After the determination, the control section 22 sorts the input information indicating the digit number or hierarchy on each delivery station basis and performs counting of the input information by accumulating them in the summary data table 24b of the data accumulation section 24 (step S26). As a result, the summary data representing the per-digit or per-hierarchy number of input information for each delivery station are stored in the summary data table 24b.

When determining in step S18 that the determination section 21 could not identify the information indicating a destination delivery station, that is, the determination section 21 could not identify a destination delivery station as information necessary to sort mails (Yes in step S18, the control section 11 uses the accumulation section 20 to accumulate the mail (step S27). In this case, the control section 11 associates the image of the mail read out by the readout section 15 and mail ID appended to the mail by the ID code print section 17 with each other to generate input information corresponding to one mail and transfers it to the server unit 7.

After receiving the input information from the sorting apparatus main body 6, the controller 22 of the server unit 7 stores the input information from the sorting apparatus main body 6 in the image information storage section 23 (step S28). The control section 22 of the server unit 7 transfers the input information stored in the image information storage section 23 to the information input unit 8, considering the processing situation of the information input unit 8. The address information then input to the information input unit 8 based on the input information transferred from the server unit 7 (step S29). For example, the information input unit 8 displays the image of the mail on a display unit (not shown) and receives an input of the address information from the operator.

At this time, as described above, the information input unit 8 requires the operator to input the address information up to the level defined by the abovementioned operation rule in principle. However, the mail can be sorted based on only the information indicating a destination delivery station even if the information satisfying the required level has not been input. That is, although it is necessary to input the address information up to the required level in the operation rule, there is actually the possibility of absence of the required part of the address information.

After the operator has input the required information, the information input unit 8 associates the input address information and mail ID with each other and sends it to the server unit 7 as processed data. Upon receiving the processed data from the information input unit 8, the control section 22 of the server unit 7 stores, in the data storage section 24, the input information and mail ID in an associated manner based on the processed data received by the information input unit 8 (step S30) and stores, in the input information database 24a, the input information on each delivery station basis (step S31).

After storing the processed data from the information input unit 8 in the input information database 24a, the control section 22 of the server unit 7 determines a destination delivery station, the digit number or hierarchy of the input information from the processed data received from the information input unit 8 (step S32). After the determination, the control section 22 sorts the input information indicating the digit number or hierarchy on each delivery station basis and perform counting of the input information by accumulating them in the summary data table 24b of the data accumulation section 24 (step S33). As a result, the summary data representing the per-digit or per-hierarchy number of input information for each delivery station are stored in the summary data table 24b.

The counting processing in steps 25 to 26 and in steps S32 to S33 may be executed separately from the processing flow of the dispatch sorting. For example, the control section 22 of the server unit 7 may perform the counting of the input information according to an instruction from an operator or administrator. In this case, the control section 22 counts the per-digit or per-hierarchy number of input information for each delivery station based on the information stored in the input information database 24a to create the summary data table 24b.

The counting of the input information may be executed by the center server 2. In this case, the control section 22 of the server unit 7 transfers the information stored in the input information database 24a to the center server 2, and the server 2 counts the per-digit or per-hierarchy number of input information for each delivery station based on the information stored in the input information database 24a received from the server unit 7 to create a summary data table similar to the summary data table 24b.

The mails whose destination delivery stations have not been identified in step S18 have been accumulated in the accumulation section 20 in step S26. Therefore, the mails accumulated in the accumulation section 20 are fed to the feed section 13 once again (step S34) after information has been input to the information input unit 8 (that is, after the mail ID and input information have been stored in the data storage section 24 in an associated manner). The mails that have been re-fed to the feed section 13 are then sorted into a destination delivery station by the sorting section 19 based on the ID code readout by the barcode readout section 16 and input information stored in the input information database 24a (step S35).

The summary data stored in the summary data table 24b of the server unit 7 may be transferred to the center server 2 via the communication interface 25. In this case, the center server 2 can collectively manage results of input processing in the dispatch sorting performed by the sorting systems 1 of the respective collection stations. As a result, the center server 2 can evaluate the processing amount and processing quality of the collection stations and thereby it can represent a dispatch sorting improvement request or a reward corresponding to the processing achievement with a numeric value based on the evaluation described above.

As described above, in the present embodiment, the sorting system 1 performs the dispatch sorting to sort mails into delivery stations, as well as to store information input through the information input unit 8 in the input information database 24a and store the summary data representing the per-digit or per-hierarchy number of input information for each delivery station in the summary data table based on the input information stored in the input information database 24a. This makes it possible to easily evaluate the status or quality of the information input processing in the dispatch sorting by referring to the information stored in the summary data table.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A sorting apparatus which sorts mails, comprising:
an input section which inputs sorting information appended to the mails;
a sorting section which sorts the mails based on the information input through the input section as the sorting information;
a determination section which determines the ratio of the information input through the input section as the sorting information relative to the entire sorting information of the mails sorted by the sorting section; and
a counting section which counts the determination results obtained by the determination section.

2. The sorting apparatus according to claim 1, further comprising:
a readout section which reads out an image on the mails; and
an identification section which identifies the sorting information appended to the mails based on the image read out by the readout section, wherein
the input section receives an input of the sorting information of the mails whose sorting information could not be identified by the identification section.

3. The sorting apparatus according to claim 1, wherein
the counting section sorts the information input through the input section as sorting information based on specified information included in the sorting information and counts the determination results obtained by the determination section for each sort.

4. The sorting apparatus according to claim 1, wherein
the sorting information is information including a plurality of hierarchies,
the determination section determines to which hierarchy level of the sorting information the information input through the input section includes, and
the counting section counts the number of sorting information input through the input section for each hierarchy determined by the determination section.

5. The sorting apparatus according to claim 4, wherein
the counting section sorts the information input through the input section as sorting information based on specified upper-hierarchy information included in the sorting information and counts the number of information input through the input section as the sorting information for each sort and for each hierarchy determined by the determination section.

6. A mail processing system having a sorting apparatus which sorts mails, a server unit which can communicate with the sorting apparatus, and an input unit which inputs sorting information appended to the mails, wherein
the sorting apparatus comprises:
a sorting section which sorts the mails based on the information input through the input unit as the sorting information; and
a transmission section which transmits, to the server unit, information input through the input unit as the sorting information for the mails sorted by the sorting section, and
the server unit comprises:
a determination section which determines the ratio of the information input through the input unit of the sorting apparatus as the sorting information relative to the entire sorting information of the mails sorted by the sorting section of the sorting apparatus based on the information received from the sorting apparatus; and
a counting section which counts the determination results obtained by the determination section.

7. The mail processing system according to claim 6, wherein
the sorting apparatus further comprises:
a readout section which reads out an image on the mails; and
an identification section which identifies the sorting information appended to the mails based on the image read out by the readout section, and
the input unit receives an input of the sorting information of the mails whose sorting information could not be identified by the identification section.

8. The mail processing system according to claim 6, wherein
the counting section of the server unit sorts the information input through the input unit as sorting information based on specified information included in the sorting information and counts the determination results obtained by the determination section for each sort.

9. The mail processing system according to claim 6, wherein
the sorting information is information including a plurality of hierarchies,
the determination section of the server unit determines to which hierarchy level of the sorting information the information input through the input unit as the sorting information includes, and
the counting section of the server unit counts the number of sorting information input through the input section for each hierarchy determined by the determination section.

10. The mail processing system according to claim 9, wherein
the counting section of the server unit sorts the information input through the input unit as sorting information based on specified upper-hierarchy information included in the sorting information and counts the number of information input through the input section as the sorting information for each sort and for each hierarchy determined by the determination section.

11. A sorting method for sorting mails, comprising:
inputting a sorting information appended to the mails;
sorting the mails based on the information input as the sorting information;
determining the ratio of the input information relative to the entire sorting information of the sorted mails; and
counting the determination results.

12. The sorting method according to claim 11, further comprising:
reading out an image on the mails; and
identifying the sorting information appended to mails based on the read out image, wherein
the inputting including inputting the sorting information of the mails whose sorting information could not be identified.

13. The sorting method according to claim 11, wherein
the counting includes sorting the information input as sorting information based on specified information included in the sorting information and counting the determination results for each sort.

14. The sorting method according to claim 11, wherein
the sorting information is information including a plurality of hierarchies,
the determining includes determining to which hierarchy level of the sorting information the input information includes, and
the counting includes counting the number of the information input as the sorting information for each determined hierarchy.

15. The sorting method according to claim 14, wherein
the counting includes sorting the information input as the sorting information based on specified upper-hierarchy information included in the sorting information and counting the number of the information input as the sorting information for each sort and for each determined hierarchy.
